(19) United States
(12) Patent Application Publication
(10) Pub. No.: US 2010/0000193 A1
(43) Pub. Date: Jan. 7, 2010

(54) Blades with multiple inclined cutting wings and winglets applied to any rotating support, suitable for cutting of grass

(76) Inventors: Mauro De Benedetto, Castello di Godego (IT); Dino Gnesotto, Castello di Godego (IT)

Correspondence Address: JACOBSON HOLMAN PLLC, 400 SEVENTH STREET N.W., SUITE 600, WASHINGTON, DC, 20004, US

(21) Appl. No.: 12/458,189

(22) Filed: Jul. 2, 2009

(30) Foreign Application Priority Data
Jul. 3, 2008 (IT) TV 2008 A000091

(51) Int. Cl. A01D 34/52

(52) U.S. Cl. 56/295

(57) ABSTRACT

Blades with multiple inclined cutting wings are applied on any rotating support. The inclination of the cutting wings or arms of the blade are carried out on the X axis with an angle that varies from 5° to 60° with regards to the frontal support. The inclination is produced by following the rotating direction. The blades are equipped with wedge-shaped upper cutting winglets which have a function of grass grinders and/or with wedge-shaped lower cutting winglets which have a function of airing and breaking grass into little pieces. These blades are produced in one single piece, or placed one upon the other or divided/split, in metal, in plastic or compound material, to be used for the cutting of a lawn.

### FIELD OF THE INVENTION

The present innovation relates to the industry that produces grass cutters equipped with electric motors and/or internal combustion engines, with at least one rotating blade for the cutting of grass.

### BACKGROUND OF THE INVENTION

In the field of electric grass or internal combustion engines or cutters, the blade has extended along an axis that is parallel to the facing cut (FIGS. 1a and 1b). Sometimes the blade is inclined for a few degrees towards the frontal area to be cut, to increase the intake towards the top of the grass cut (like a propeller). From a single blade the progression has been made to two, then three, then four, to be able to increment cutting capacity (see FIG. 1c). To further break the grass into small pieces, some grass cutters include rear grinders, that work on the condition that the lawn is not cut from too high grass.

Cutting machines are therefore produced which are always more complicated, expensive and noisy. If the single and/or multiple blade tool is not sharp, a remarkable increase in cutting time, and therefore, the relative cost, results. With one or more frontal blades the power absorbed is higher due to a great impact with the grass, leading to increased fuel consumption. The rotations/minute and therefore pollution are increased, along with the noise caused by the greater number of rotations of the engine and by the whirl caused by the inclination of the blades, similar to those of a propeller.

Regarding reduction of the friction on the grass and incidence of the cutting blade on the blades of grass to be cut, by means of innovative configurations of the tool that guarantee greater production capacity, this field is inefficient. In spite of the techniques available, the present condition of the art can detrimentally affect the external layer of the grass caused by frontal cutting stress that causes tearing of the stems.

A simple grass cutter with blades rotating in a single axis, as configured, is not able to crumble the grass sufficiently in order to leave the cut grass on a garden and be used as a natural fertilizer. Therefore, with this type of frontal blade, one can only cut the grass when it is high and can be picked up afterwards. Picking up the grass, one knows that unfortunately it must be packed and transported to residue collection centers.

### SUMMARY OF THE INVENTION

To avoid this irksome and expensive burden, the innovation of the present invention provides various solutions to obtain the crumbling of the cut grass. The various solutions that create the novelty herein have been created thanks to the use of machines that cut and edge in a precise manner with thin metals formed with a laser, in order to obtain inclined cutting wings on a support which are perfectly balanced, such as to avoid vibrations with high working revolutions and therefore provide a silent blade.

Due to this innovation, the grass cutters according to the present invention are equipped with a rotating support with inclined wings with regards to the facing cut. This innovation allows to implement an increased cutting capacity of a single blade even with not too high grass to be cut and solves the problems of cut waste from the tool with remarkably higher grass. The inclination of the cutting wings reduces the stress on the grass, as the cut takes place delicately, concentrating the force in an inclined way on the molecular bonds of the blades of grass, instead of using a cutting compression on one single row. This compression is at the moment caused by the full frontal attack of the blades on the blades of grass that at the moment are parallel to the facing cut. However, by the present invention the cut is assured without detrimentally affecting the tip of the blade of grass and it is not necessary to wait until the grass is high.

### BRIEF DESCRIPTION OF THE DRAWINGS

FIG. 1a represents a bottom view of a known mowing deck, where is shown a straight traditional blade.

FIG. 1b shows a traditional straight cutting blade.

FIG. 1c shows the lower part of a known mowing deck with triple straight blades.

FIG. 2 shows the grass bent by the deck and close to the chassis (2A); the cutting winglets placed on the external and lower part of the cutting blade (2B); and the flow deviators (2C).

FIG. 3 shows the cutting winglets placed on the external and upper part of the cutting blade (3A); the cutting winglets placed on the external and lower part of the cutting blade (3B); and the flow deviators, behind the upper winglets (3C).

FIG. 4 shows a blade which is mechanically separated into two distinct inclined pieces to be placed one on top of each other and divided by a spacer, with lower winglets and dimensions in mm.

FIGS. 5a-5c show how a blade, as per FIG. 4, is formed, and including a circular arrow indicative of direction of rotation.

FIGS. 6a -6c and 7a -7b show twin wing inclined blades which include two different inclinations, with lower winglets and dimensions in mm, and including a circular arrow indicative of direction of rotation.

FIGS. 8a -8b and 9a -9b show triple inclined wing blades with two different inclinations, with lower winglets and dimensions in mm, and including a circular arrow indicative of direction of rotation.

FIGS. 10a -10e and 11a -11d show quadruple inclined wing blades with two different inclinations, with upper-lower winglets and dimensions in mm., which can be welded inside the external grooves on two wings, and including a circular arrow indicative of direction of rotation.

FIG. 12 shows how a guillotine blade works.

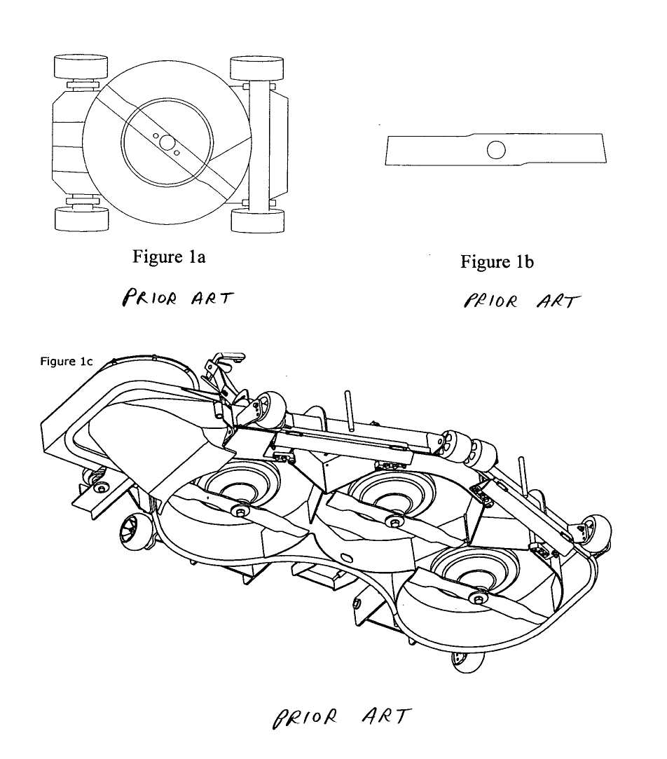

### DETAILED DESCRIPTION OF PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

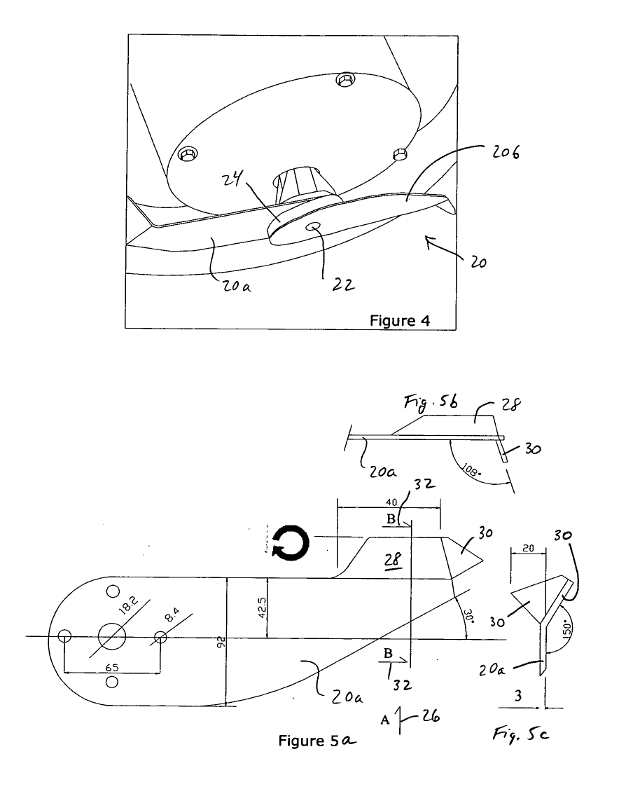

With reference to the drawings, and to FIGS. 4 and 5a-5c, a two-piece blade embodiment teaching the subject invention is generally designated as 20. In FIG. 4, there are two blade pieces 20a , 20b mounted on a support shaft 22 and having a spacing disc 24 between the two blade pieces. The details of the blade pieces 20a , 20b are shown by reference to a single blade piece 20a as shown in FIG. 5a . As shown in the direction of arrow 26, in more detail in FIG. 5b , the blade piece includes an upward projection or inclined wing 28 and a wedge-shaped winglet 30. As shown in FIG. 5c , looking in the direction of arrows 32, winglet 30 is a downwardly projecting winglet extending from the 3 mm thick blade piece 20a . It is understood that blade piece 20b would be of identical construction.

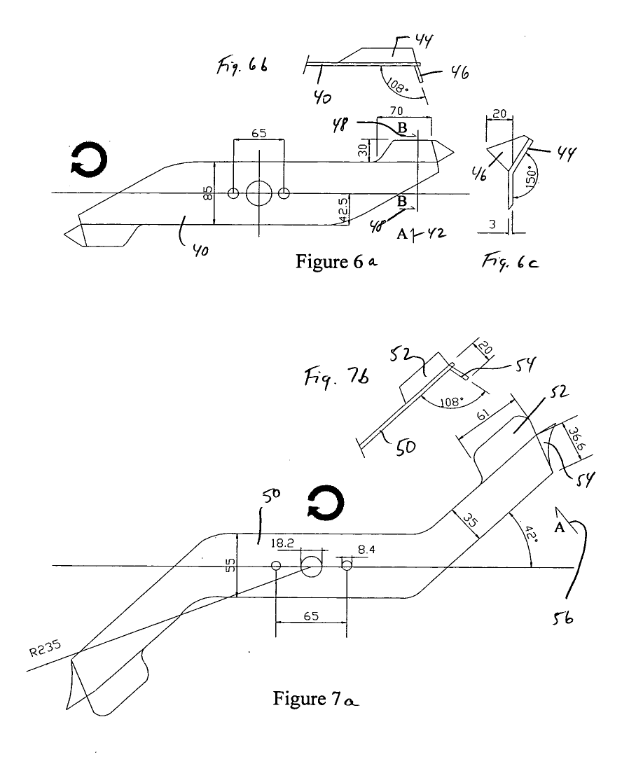

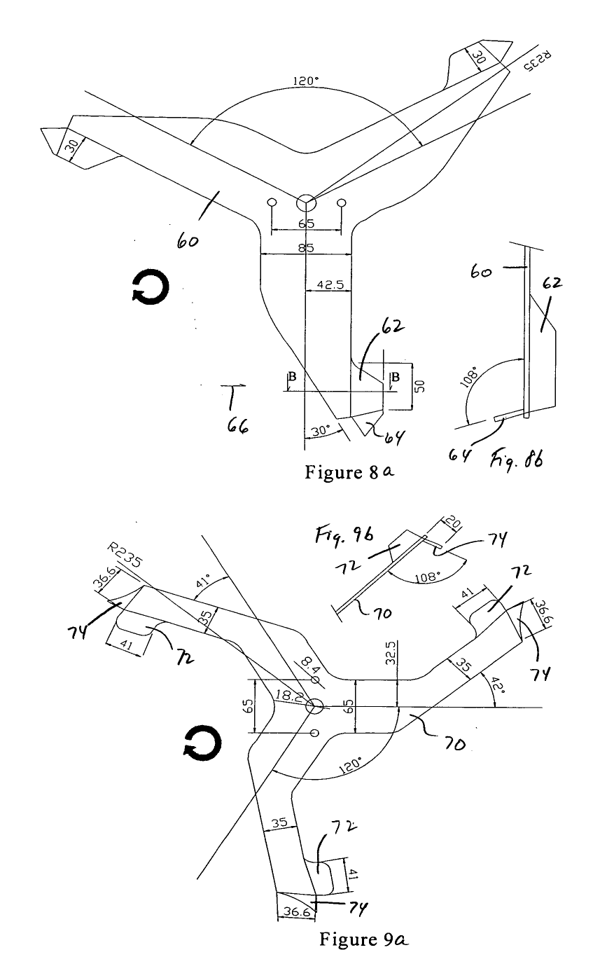

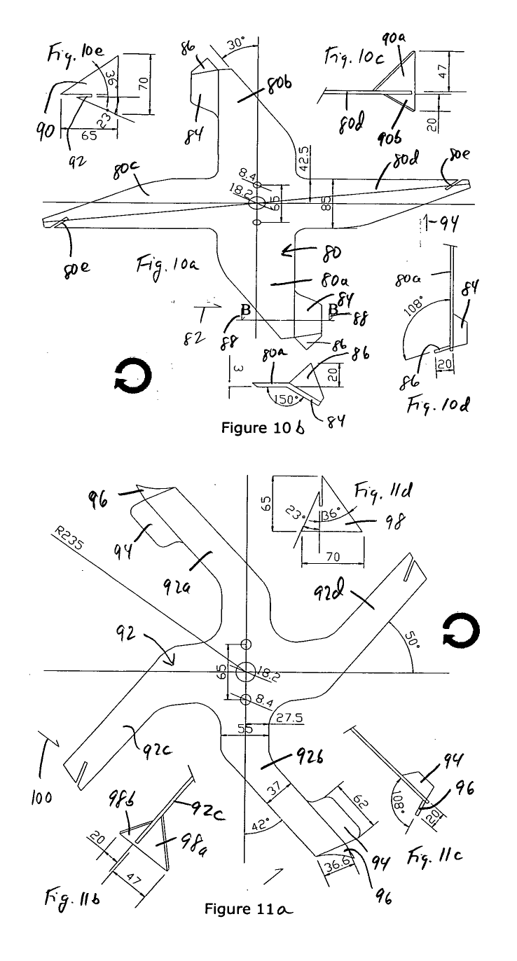

With reference to FIGS. 6a-c and 7a and 7b , various alternate embodiments are shown from single blade body pieces 40 and 50, respectively. Looking in the direction of arrow 42 in FIG. 6a , and illustrated in FIG. 6b , the blade body 40 includes upward projection or inclined wing 44 and wedge-shaped winglet 46 as also shown in FIG. 6c , looking in the direction of arrows 48 in FIG. 6a.

In FIG. 7a , the blade body 50 includes upward projection or inclined wing 52 and wedge-shaped winglet 54, as shown in more detail in FIG. 7b , looking in the direction of arrow 56 in FIG. 7a . Terminal end arms are inclined at an angle of 42° with respect to the direction of rotation as shown by circular arrow.

In FIGS. 8a , 8b , 9a and 9b , three armed blade bodies 60, 70 include upward projection or inclined wings 62 and wedge-shaped winglet 64, as shown in more detail in FIG. 8b by looking in the direction of arrow 66 in FIG. 8a . The terminal ends of the arms are inclined at an angle of 30°.

Similarly, in FIG. 9a , each arm of the blade body 70 includes an upward inclined projection 72 and wedge-shaped winglet 74. The terminal ends of the arms are inclined at an angle of 41°.

With reference to FIGS. 10a-10e and 11a-11d, alternate embodiments for attaching upper and lower winglets to a blade body are disclosed. In FIG. 10a , the blade body 80 includes arms 80a and 80b having terminal ends inclined at an angle of 30°. When looking in the direction of arrow 82, upper projection or inclined wings 84 and wedge-shaped winglets 86 are shown. Similarly, when looking in the direction of arrows 88, the projection and winglets are shown in FIG. 10b . However, with reference to arms 80c and 80d , the arms terminate in a slot 80e into which a winglet 90 having a corresponding slot 92 may be inter-engaged. Therefore, as shown by looking in the direction of arrow 94, the blade body includes upper winglet 90a and lower winglet 90b as shown in FIG. 10c.

Similarly, in FIG. 11a, two of the arms 92a , 92b of blade body 92 include an end terminating at an angle of 50° with respect to an X axis through a central part of the blade body. The other two arms 92c , 92d include a winglet 98 as shown in FIG. 11d mounted on a corresponding slot so as to form the winglets 98a , 98b as shown in FIG. 11b looking in the direction of arrow 100.

### Disclosure of Invention in Five Phases—Phase I

In the first phase, the blade is inclined with regards to the X axis, where the peripheral cutting speed is higher. Therefore the blade is no longer in the X axis, but includes a rotating and inclined wing support. The blades and the inclined wings, taking advantage of the molecular separation of the grass, on the side destined to be cut, dissects the blade of grass bringing it to the side of the edging without forcing it to be cut with violence. In practical terms, one obtains the same effect produced by a known guillotine, with a specially shaped blade. The cut would have been much more traumatic if the blade would have been right-angled to the cutting support. The inclined blades, in this way, therefore, allow a more efficient cut even if less violent.

The implementation of the present system, is therefore possible by inclining the wings of the support, rotating it in various ways and therefore not maintaining the blade in a more right-angled way with regards to the support. With the wings inclined with regards to the X axis, one permits the cut residue to come out more easily from the interested area, keeping the tool always clean. The fact that the blades have inclined wings, permits the residue to self-canalize easier in the exit/intake direction. The inclinations of the cutting wings of the blade are constructed on the X axis with an angle at the winglets that varies from 5° to 60° with regards to the frontal support. The inclination is produced by following the rotation direction and not against the rotation direction. The blade also possesses flow deviators (2C) having an inclination from 0.1° to 40° that permit an efficient unloading of the grass, as they create a whirl directed to the inside of the grass cutter frame.

### Phase II

One or more cutting winglets, of wedge-shaped shape (2B), are located below the inclined wings and at the most external part. They serve to avoid the creation of squashed and uncut areas in case of high grass (2A), caused by the squashing of masses of grass by the chassis and/or by the refusal of the tool to cut the same, caused by a too great impact (2A, grass bent close to the chassis). These lower “winglets” cut the grass when the rotating blade in the excess of material to be cut, squashes it down, trying to refuse the same. In this case the lower winglet cuts it when the grass is bent. The winglets serve also to air the lawn, as they insert themselves between the blades of grass. They do not sink into the ground, but are sufficiently long to skim the ground in order to remove the greater part of the lawn. The winglets cut the lawn and the intake of the blade, thanks to the flow deviators, lifts the cut grass from the ground. In technical slang the clippings are the layer of dead grass that tends to accumulate above the ground. The winglets have a wedge-shaped shape in order to have a facilitated penetration (2B) and possess a logical-functional angle inclined towards the outside, so that the blade of grass is evacuated according to centrifugal force. The lower winglets serve also to protect the main blade, as the winglets will be the first to meet anonymous obstacles, such as stones, wood, etc. The winglets therefore, even if deformed, will be the immediate protection for the operator, which will not compromise the integrity of the main blade.

### Phase III

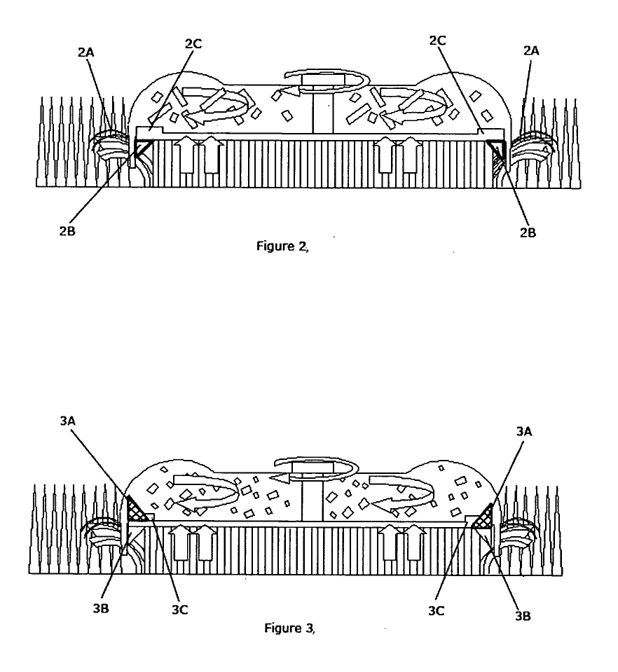

One or more cutting winglets, of wedge-shaped shape on the upper part of the blade and in the most external side (3A). They possess a logical-functional angle inclined towards the outside, so that the blade of grass is evacuated according to centrifugal force. These winglets in the shape of wedges serve to cut into small pieces the blades of grass already cut by the inclined wings and by the winglets below (3B). In fact, studies made have demonstrated that a blade of grass does various revolutions in the grass cutter body before being launched onto the ground by the canalized flow, visualized by the arrows inside FIGS. 2 and 3. With these winglets one is able to obtain better conditions to proceed to the choice “mulching”, which is not only to grind the grass better but to leave it on the lawn as fertilizer. The crumbled grass gives the nutritive elements to the ground and this permits a considerable saving of fertilizer, also helping to reduce the dehydration of the lawn. As said, the upper winglets permit crumbling of the grass so that it does not get collected but left on the ground in fine particles, reducing burdens, costs and time.

### Phase IV

In order to reduce the noisiness of the joined machine-blades, with the configurations indicated above, it has been decided to use blades of inferior thickness, that is of only 3 mm with a diameter of 480/500 mm as contrasted with a normal thickness of 4 mm. That is, it was possible to reduce the thickness of the blade −25%. This also permits the reduction of stress and consumptions, as the thinner the blade, the greater the pressure that one is able to exercise on the area to be cut. The weight of the blade is reduced, and the energy required for the rotation of the tool is also reduced.

### Phase V

The cutting tool, conceived in this way has been realized with two, three and four cutting wings. The blades are produced in one single piece while they can also be realized in two distinct pieces to be placed one on top of each other (FIG. 4). The blades with three and four cutting wings (FIGS. 6-7/8-9/10-11) possess greater cutting capacities and therefore the engine power and the fuel consumption can be reduced, with the same working conditions as two blades.

### Technical Characteristics of the Solution

A sharp blade is fundamental for a good cut. The thinner the blade, the greater is the pressure that one is able to exercise on the object to be cut. The pressure (P) is given by the force perpendicularly applied on the level (F¹⁹⁵) divided by the surface of the application level (A), therefore:

$$P = \frac{F ⊥}{A}$$

A sharp blade permits minimization of the application area A in order to maximize the pressure exercised. Only the pressure is not sufficient for a good cut. It is common experience that letting the knife blade slide on the object to be cut, one obtains a cut which is easier and more precise (example: cut of bread and of ham). This is because applying a cutting force is more efficient in separating the molecules one from the other, instead of applying a single pressure force on the same, seeing that by doing this one concentrates the force on the single molecular bonds instead of compressing an entire row. The shear (T) is given by the force applied parallel to the plane (F//) divided by the application plane surface (A). Therefore:

$$T = \frac{F //}{A}$$

Also in this case, a sharp blade allows minimization of the application area A in order to maximize the exercised cutting force. To summarize, the cutting force permits to break the molecular bonds in a more suitable way, while the pressure allows the breakage line of the molecular bond to advance into the object to be cut.

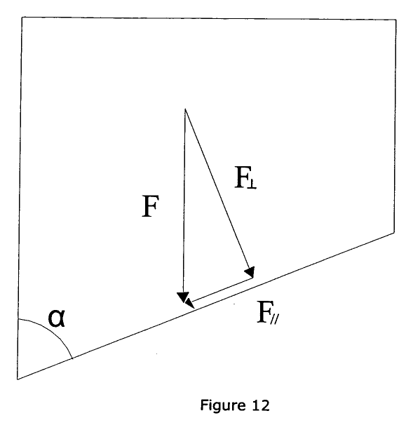

In FIG. 12, one can see a guillotine blade with the characteristic trapezoidal shape. The guillotine acts from the top towards the bottom, moved by its own force weight F=mg, where m is the mass of the blade, plus a possible weight placed on top of it, and g is the gravity acceleration. Thanks to the special shape of this type of blade, this force, F can be composed of two components (in FIG. 12) with regards to the system of the two Cartesian axes, given by the thread of the blade and by the perpendicular component, on the level of the blade. Therefore F//=F cos α to the parallel component to the blade thread and F=F sin α to the perpendicular component to the blade thread. In this way it is possible to use a simple movement, like that of free fall, in order to apply on the object to be cut both pressure and cutting stress. The guillotine cut is the closest example to the innovation, where in place of free fall it is rotation of the blade that moves the inclined cutting appendix. Connecting to what is described above, in the conditions of a grass cutter superior cutting capacity is obtained. In this case optimization of a tool cut has been performed.

### Property of the Innovation

Better cut with the same number of blades; extended life of the blade thread; cutting facility without having to repeat the cut of the grass; less stressful cutting on the blade of grass, especially on hard blades of grass; better evacuation of the cutting residue (blades of grass cut), as the same has the possibility of flowing, following the whirl created by the special shape of the blade.

### Economical Aspect of the Innovation

The life of the blade thread is remarkably superior to a blade placed frontally, with a cutting capacity remarkably superior with a same number of blades. The application of the single or multiple inclination is simple. Therefore the cost of the tool (even if of high technology) has been brought to an acceptable value.

### Innovation

To allow one to use the existing rotating grass cutter machines, by installing the blades with single or multiple inclination with inclined appendix, increasing in this way the cutting capacity and quality of the existing grass cutter machines, without having to increase the engine horsepower used. The blades with inclined wings can assume different combinations as emphasized in FIGS. 6-11.

### Best Mode for Carrying Out the Invention

The achievement of the single or double inclination is obtained in various or simple ways. It is possible to pre-mould blades already inclined or produce blades with laser cut and later on, with mechanical bending, obtain the requested inclinations of the various cutting winglets. The sharpening can be carried out manually or mechanically, according to the inclination degree requested by the cutting thread.

### Industrial Applicability

In the industry ambit of the grass cutting machines, in general, by means of rotating blades, by replacing the frontal blades with those specified in this innovation, being able in this way to strengthen the cutting capacity of the machine, reducing the cutting costs, leaving the cut grass on the lawn, improving the aesthetic look of the cut lawn, reducing fuel consumption, reducing the acoustic pollution and in the machines with internal combustion motors, reducing the pollution from harmful emissions.

While several embodiments of the present invention have been shown and described, alternate embodiments and combination of embodiments and/or features will be apparent to those skilled in the art and are within the intended scope of the present invention.

I claim:

1. A grass cutting blade comprising
a blade body having at least two inclined cutting arms, said arms being located at terminal ends of the blade body, the cutting arms rotating at a peripheral speed higher than a centrally located portion of the blade body,
the cutting arms having an inclination with respect to an X axis extending through the central portion of the blade body, at an angle from 5° to 60°,
the inclination of the cutting arms follows a rotation direction of the blade body.

2. The grass cutting blade of claim 1, wherein the cutting arms include at least one of upper wedge-shaped cutting winglets for grinding grass and lower wedge-shaped cutting winglets for cutting grass.

3. The grass cutting blade of claim 1, wherein the blade body includes two pieces, one piece placed on top of the other piece.

4. The grass cutting blade of claim 1, wherein the blade body is made of plastic material.

5. The grass cutting blade of claim 1, wherein the cutting arms include flow deviators.

6. The grass cutting blade of claim 5, wherein the flow deviators have an inclination up to 40°.
